(19) United States
(12) Patent Application Publication
(10) Pub. No.: US 2024/0148002 A1
(43) Pub. Date: May 9, 2024

(54) BIOCIDAL COMPOSITIONS CONTAINING COPPER AND A CO-BIOCIDE

(71) Applicant: CORNING INCORPORATED, CORNING, NY (US)

(72) Inventors: Bavani Balakrisnan, Corning, NY (US); Stephen Joseph Caracci, Elmira, NY (US); David Michael Fasano, Lansdale, PA (US); Joseph Martin Rokowski, Barto, PA (US)

(21) Appl. No.: 18/280,414

(22) PCT Filed: Mar. 7, 2022
(86) PCT No.: PCT/US2022/019068

§ 371 Date: Sep. 5, 2023

Related U.S. Application Data
(60) Provisional application No. 63/158,710, filed on Mar. 9, 2021.

(51) Int. Cl. A01N 59/20; A01N 25/12; A01N 33/20; A01N 43/76; A01N 43/80; C09D 5/14; C09D 7/61; C09D 7/63; C08K 3/40; C08K 5/32; C08K 5/353; C08K 5/47; C08K 13/02

(52) U.S. Cl. CPC A01N 59/20; A01N 25/12; A01N 33/20; A01N 43/76; A01N 43/80; C09D 5/14; C09D 7/61; C09D 7/63; C08K 3/40; C08K 5/32; C08K 5/353; C08K 5/47; C08K 13/02

(57) ABSTRACT

A biocidal material includes a carrier, a plurality of copper-containing glass particles, and at least one co-biocide selected from isothiazolinones, bicyclic oxazolidines, and bromine nitrogen-based compounds. A minimum bactericidal concentration (MBC) of a combination of the at least one co-biocide and the plurality of copper-containing glass particles is less than an MBC of the at least one co-biocide in the absence of the plurality of copper-containing glass particles.

### CROSS REFERENCE TO RELATED APPLICATION

This application claims the benefit of priority under 35 U.S.C. § 119 of U.S. Provisional Application No. 63/158,710, filed on Mar. 9, 2021, the content of which is relied upon and incorporated herein by reference in its entirety.

### FIELD

The present disclosure relates generally to materials having biocidal properties and methods of forming said materials, and more particularly to biocidal materials containing copper and a co-biocide and methods of forming.

### BACKGROUND

Coating compositions such as paint, resins, adhesives, etc. can be stored in a container and then applied to a surface to form a coating. The coating compositions can be exposed to micro-organisms, such as bacteria, viruses, mildew, mold, fungi, algae and the like, during storage (e.g., in-can) and after being applied to a surface that can affect the properties of the composition and the coatings formed by these compositions. Exposure to micro-organisms may affect the viscosity, pH, color, and/or smell of a composition and/or a coating formed by the composition. In addition, micro-organisms may also affect product function and/or efficacy, produce a gas, and/or result in visible surface growth or biofilm formation.

Biocides can be added to the coating compositions as a preservative to slow and/or inhibit the growth of micro-organisms during storage and/or after application of the coating composition to a surface. However, some biocides can be cost-prohibitive to use in concentrations high enough to provide a desired level of efficacy. It can also be challenging to find biocides that are effective against a wide range of micro-organisms and which are stable during storage. The biocidal properties of a number of inorganic materials, especially metals such as silver, copper, zinc, mercury, tin, gold, lead, bismuth, cadmium, chromium and thallium, have long been known. Metals such as silver, zinc, gold, and copper have been utilized for their biocidal properties due to their relatively low environmental and toxicological effects and high biocidal activity. However, high concentrations of these metals used to achieve a desired level of efficacy against a wide range of micro-organisms, may be cost prohibitive and/or have undesirable effects on the coating composition during storage and/or use. Some organic biocides are effective against a wide range of micro-organisms; however, many organic biocides can be cost prohibitive to utilize, and thus, it is often desirable to use as little of these organic biocides as acceptable to achieve the desired level of efficacy.

Thus, there is a need for inorganic and organic materials that exhibit improved biocidal efficacy when utilized together compared to either material alone.

### SUMMARY

According to an embodiment of the present disclosure, a biocidal material includes a carrier, a plurality of copper-containing glass particles, and at least one co-biocide selected from isothiazolinones, bicyclic oxazolidines, and bromine nitrogen-based compounds. A minimum bactericidal concentration (MBC) of a combination of the at least one co-biocide and the plurality of copper-containing glass particles is less than an MBC of the at least one co-biocide in the absence of the plurality of copper-containing glass particles. A ratio of the amount of the at least one co-biocide to the amount of copper-containing glass particles (in weight percent) is from about 3:1 to about 1:3.

According to another embodiment of the present disclosure, a biocidal paint includes a film-forming component, a solvent, a plurality of copper-containing glass particles, and at least one co-biocide selected from isothiazolinones, bicyclic oxazolidines, and bromine nitrogen-based compounds. A minimum bactericidal concentration (MBC) of a combination of the at least one co-biocide and the plurality of copper-containing glass particles is less than an MBC of the at least one co-biocide in the absence of the plurality of copper-containing glass particles. A ratio of the amount of the at least one co-biocide to the amount of copper-containing glass particles (in weight percent) is from about 3:1 to about 1:3.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a plot illustrating the colony count of Pseudomonas aeruginosa (P. aeruginosa) following a treatment period of 24 hours with the indicated concentrations of the following materials: Nuosept® 95 (Ex. 1A), a 50:50 mixture of Nuosept® 95 and copper-containing glass particles (Ex. 1B), a 25:75 mixture of Nuosept® 95 and copper-containing glass particles (Ex. 1C), and copper-containing glass particles (Ex. 4A and 4B), according to aspects of the present disclosure;

FIG. 2 is a plot illustrating the colony count of P. aeruginosa following a treatment period of 24 hours with the indicated concentrations of the following materials: benzisothiazolinone (BIT) (Ex. 2A), a 50:50 mixture of BIT and copper-containing glass particles (Ex. 2B), a 25:75 mixture of BIT and copper-containing glass particles (Ex. 2C), and copper-containing glass particles (Ex. 4A and 4B), according to aspects of the present disclosure; and

FIG. 3 is a plot illustrating the colony count of P. aeruginosa following a treatment period of 24 hours with the indicated concentrations of the following materials: Bronopol (Ex. 3A), a 50:50 mixture of Bronopol and copper-containing glass particles (Ex. 3B), a 25:75 mixture of Bronopol 95 and copper-containing glass particles (Ex. 3C), and copper-containing glass particles (Ex. 4A and 4B), according to aspects of the present disclosure.

### DETAILED DESCRIPTION

Reference will now be made in detail to the present embodiment(s), an example(s) of which is/are illustrated in the accompanying drawings. Whenever possible, the same reference numerals will be used throughout the drawings to refer to the same or like parts.

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

As used herein, “have,” “having,” “include,” “including,” “comprise,” “comprising” or the like are used in their open ended sense, and generally mean “including, but not limited to.”

All scientific and technical terms used herein have meanings commonly used in the art unless otherwise specified. The definitions provided herein are to facilitate understanding of certain terms used frequently herein and are not meant to limit the scope of the present disclosure.

The present disclosure is described below, at first generally, then in detail on the basis of several exemplary embodiments. The features shown in combination with one another in the individual exemplary embodiments do not all have to be realized. In particular, individual features may also be omitted or combined in some other way with other features shown of the same exemplary embodiment or else of other exemplary embodiments.

According to aspects of the present disclosure, a biocidal material is disclosed which includes a plurality of copper-containing glass particles and at least one organic co-biocide selected from isothiazolinones, bicyclic oxazolidines, and bromine nitrogen-based compounds that exhibits a synergistic effect. In some aspects, the biocidal material can be used with a composition, such as a paint composition, and act as an in-can preservative to kill or inhibit the growth of microbes in the composition during the shelf-life of the composition (e.g., during storage and/or during processing steps prior to the composition's end use application). A decrease in the minimum bactericidal concentration (MBC) of a combination of the copper-containing glass particles and the organic co-biocides compared to the MBC of the organic co-biocide alone (e.g., in the absence of the copper-containing glass particles) can be used as an indication of a synergistic biocidal effect between the copper-containing glass particles and the organic co-biocides.

As used herein, the term “biocidal,” means a material, or a surface of a material that will kill or inhibit the growth of microbes including bacteria, viruses, mildew, mold, algae, and/or fungi. The term as used herein does not mean the material or the surface of the material will kill or inhibit the growth of all species of microbes within such families, but that it will kill or inhibit the growth of one or more species of microbes from such families.

The minimum bactericidal concentration (MBC) values reported herein were determined using Pseudomonas aeruginosa (P. aeruginosa), which is a gram-negative pathogen that can cause severe acute and chronic infections. The MBC is the lowest biocide or biocide combination concentration that kills 100% of the tested bacteria. The cultures of P. aeruginosa were grown for 24 hours in Letheen Broth before treatment with each biocide (e.g., copper-containing glass particles or organic co-biocide) or biocide combination (e.g., copper-containing glass particles and an organic co-biocide). A stock copper-containing glass particle dispersion containing 10 wt % copper-containing glass particles and 1.5% hydoxyethylcellulose (HEC) thickener (Natrosol™ Plus 330 PA) was prepared for serial dilution in thickened Letheen Broth (Letheen Broth containing 1.5 wt % HEC thickener) to achieve the desired test concentrations. A stock organic co-biocide or biocide combination dispersion was prepared by combining 5 grams of a 1 wt % dispersion of each organic co-biocide or biocide combination in 1 wt % HEC thickener for serial dilution to achieve the desired test concentrations. 1000 μL of the dispersion of interest was added to a microcentrifuge tube (referred to as “tube 1”). Serial dilution continued with the dilution of 500 μL of the dispersion from tube 1 with 500 μL of thickened Letheen Broth (“tube 2”). Serial dilutions were continued in this manner 9 additional times (tube 3 to tube 10). Tube 11 contained 500 μL of thickened Letheen Broth as a “broth blank.” 50 μL of P. aeruginosa was transferred directly from culture into each of tubes 1-11 and the tubes were incubated at 37° C. for 24 hours. At the end of the incubation period, each tube 1-11 was plated and the plates were incubated at 37° C. for 24 hours. At the end of the incubation period, the plates were removed and the colonies on each plate were counted and recorded.

Unless otherwise specified, the terms “paint” and “coating” are used interchangeably to refer to materials that are applied to a surface to provide the surface with a decorative and/or functional finish. Exemplary materials that can be used in a paint according to aspects of the present disclosure can include any material that provides a colored, decorative, aesthetic, and/or functional finish to a surface, and which may include colored pigments, aqueous solvents, non-aqueous solvents, polymeric materials, iridescent pigments, corrosion prevention additives, ultraviolet (UV) protection additives, metal flakes/particles, scratch-resistant additives, and/or stain-resistant additives, etc. Non-limiting examples of a paint as used herein includes a base or primer coat material, pigmented, metallic, and/or pearlescent paints, stains (e.g., for use on natural wood and/or composite materials), protective topcoats, clear coats, adhesives, polymer dispersions (e.g., used in paints and adhesives), caulk, fabric treatment, sealant, and printing inks.

In some aspects, the biocidal material of the present disclosure can include a plurality of copper-containing glass particles and at least one co-biocide selected from isothiazolinones, bicyclic oxazolidines, and bromine nitrogen-based compounds. In some aspects, the biocidal material can be incorporated into a biocidal paint.

The copper-containing glass particles of the present disclosure can include an inorganic glass comprising a copper component that may include a Cu species. According to aspects of the present disclosure, the Cu species may include Cu¹⁺, Cu⁰, and/or Cu²⁺. The combined total of the Cu species may be about 10 wt % or more of the glass. However, as will be discussed in more detail below, the amount of Cu²⁺ may be minimized or reduced such that the inorganic glass comprising a copper component is substantially free of Cu²⁺. The Cu¹⁺ ions may be present on or in the surface and/or the bulk of the inorganic glass comprising a copper component. In some embodiments, the Cu¹⁺ ions are present in a glass network and/or a glass matrix of the inorganic glass comprising a copper component. Where the Cu¹⁺ ions are present in the glass network, the Cu¹⁺ ions are atomically bonded to the atoms in the glass network. Where the Cu¹⁺ ions are present in the glass matrix, the Cu¹⁺ ions may be present in the form of Cu¹⁺ crystals that are dispersed in the glass matrix. Where the Cu¹⁺ ions are present, regardless of whether the ions are in a non-crystalline or crystalline form, the material may be referred to as a copper-containing glass. In some aspects, both Cu¹⁺ crystals and Cu¹⁺ ions not associated with a crystal are present in the copper-containing glasses described herein.

According to aspects of the present disclosure, the copper-containing glass particles may be formed from a glass composition that can include, in mole percent (mol %), SiO₂ in the range of from about 30 mol % to about 70 mol %, Al₂O₃ in the range of from about 0 mol % to about 20 mol %, a copper-containing oxide in the range of from about 10 mol % to about 50 mol %, CaO in the range of from about 0 mol % to about 15 mol %, MgO in the range of from about 0 mol % to about 15 mol %, P₂O₅ in the range from about 0 mol % to about 25 mol %, B₂O₃ in the range of from about 0 mol % to about 25 mol %, K₂O in the range of from about 0 mol % to about 20 mol %, ZnO in the range of from about 0 mol % to about 5 mol %, Na₂O in the range of from about 0 mol % to about 20 mol %, and/or Fe₂O₃ in the range of from about 0 mol % to about 5 mol %. In some examples, the amount of the copper-containing oxide is greater than the amount of Al₂O₃. In some examples, the glass composition may include a content of R₂O, where R may include K, Na, Li, Rb, Cs, and combinations thereof.

The copper-containing glass particles can be formed from a glass composition that may include SiO₂ as the primary glass-forming oxide. The amount of SiO₂ present in a glass composition should be enough to provide glasses that exhibit the requisite chemical durability suitable for its use or application (e.g., paint). The upper limit of SiO₂ may be selected to control the melting temperature of the glass compositions described herein. For example, excess SiO₂ could drive the melting temperature at 200 poise to high temperatures at which defects such as fining bubbles may appear or be generated during processing and in the resulting glass. Furthermore, compared to most oxides, SiO₂ decreases the compressive stress created by an ion exchange process of the resulting glass. In other words, glass formed from glass compositions with excess SiO₂ may not be ion-exchangeable to the same degree as glass formed from glass compositions without excess SiO₂.

The copper-containing glass particles can be formed from a glass composition that may include SiO₂ in an amount, in mole percent, in the range of from about 30 to about 70, from about 30 to about 69, from about 30 to about 68, from about 30 to about 67, from about 30 to about 66, from about 30 to about 65, from about 30 to about 64, from about 30 to about 63, from about 30 to about 62, from about 30 to about 61, from about 30 to about 60, from about 40 to about 70, from about 45 to about 70, from about 46 to about 70, from about 48 to about 70, from about 50 to about 70, from about 41 to about 69, from about 42 to about 68, from about 43 to about 67, from about 44 to about 66, from about 45 to about 65, from about 46 to about 64, from about 47 to about 63, from about 48 to about 62, from about 49 to about 61, from about 50 to about 60, and all ranges and sub-ranges there between. In some examples, the glass phase of the glass composition includes more than 40 mol % SiO₂. For example, the glass phase of the glass composition can include more than 40 mol % SiO₂, more than 45 mol % SiO₂, more than 50 mol % SiO₂, more than 55 mol % SiO₂, or more than 60 mol % SiO₂.

The copper-containing glass particles can be formed from a glass composition that may include Al₂O₃ an amount, in mole percent, in the range from about 0 to about 20, from about 0 to about 19, from about 0 to about 18, from about 0 to about 17, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1, from about 0.4 to about 1, from about 0.5 to about 1, from about 0 to about 0.5, from about 0 to about 0.4, from about 0 to about 0.3 from about 0 to about 0.2, from about 0 to about 0.1, and all ranges and sub-ranges there between. In some aspects, the glass composition is substantially free of Al₂O₃. As used herein, the phrase “substantially free” with respect to the components of the glass composition and/or the resulting glass means that the component is not actively or intentionally added to the glass compositions during initial batching or subsequent post processing (e.g., ion exchange process), but may be present as an impurity. For example, a glass composition may be described as being substantially free of a component, when the component is present in an amount of less than about 0.01 mol %.

The amount of Al₂O₃ may be adjusted to serve as a glass-forming oxide and/or to control the viscosity of molten glass compositions. Without wishing to be bound by theory, it is believed that when the concentration of alkali oxide (R₂O) in a glass composition is equal to or greater than the concentration of Al₂O₃, the aluminum ions are found in tetrahedral coordination with the alkali ions acting as charge-balancers. This tetrahedral coordination greatly enhances various post-processing (e.g., ion exchange process) of glasses formed from such glass compositions. Divalent cation oxides (RO) can also charge balance tetrahedral aluminum to various extents. While elements such as calcium, zinc, strontium, and barium behave equivalently to two alkali ions, the high field strength of magnesium ions causes them to not fully charge balance aluminum in tetrahedral coordination, resulting in the formation of five- and six-fold coordinated aluminum. Generally, Al₂O₃ can play an important role in ion-exchangeable glass compositions and strengthened glasses since it enables a strong network backbone (e.g., high strain point) while allowing for the relatively fast diffusivity of alkali ions. However, when the concentration of Al₂O₃ is too high, the glass composition may exhibit lower liquidus viscosity and, thus, Al₂O₃ concentration may be controlled within a reasonable range. Moreover, as will be discussed in more detail below, excess Al₂O₃ has been found to promote the formation of Cu²⁺ ions, instead of the desired Cu¹⁺ ions.

The copper-containing glass particles can be formed from a glass composition that may include a copper-containing oxide in an amount, in mole percent, in the range of from about 10 to about 50, from about 10 to about 49, from about 10 to about 48, from about 10 to about 47, from about 10 to about 46, from about 10 to about 45, from about 10 to about 44, from about 10 to about 43, from about 10 to about 42, from about 10 to about 41, from about 10 to about 40, from about 10 to about 39, from about 10 to about 38, from about 10 to about 37, from about 10 to about 36, from about 10 to about 35, from about 10 to about 34, from about 10 to about 33, from about 10 to about 32, from about 10 to about 31, from about 10 to about 30, from about 10 to about 29, from about 10 to about 28, from about 10 to about 27, from about 10 to about 26, from about 10 to about 25, from about 10 to about 24, from about 10 to about 23, from about 10 to about 22, from about 10 to about 21, from about 10 to about 20, from about 11 to about 50, from about 12 to about 50, from about 13 to about 50, from about 14 to about 50, from about 15 to about 50, from about 16 to about 50, from about 17 to about 50, from about 18 to about 50, from about 19 to about 50, from about 20 to about 50, from about 10 to about 30, from about 11 to about 29, from about 12 to about 28, from about 13 to about 27, from about 14 to about 26, from about 15 to about 25, from about 16 to about 24, from about 17 to about 23, from about 18 to about 22, from about 19 to about 21 and all ranges and sub-ranges therebetween. According to embodiments of the present disclosure, the copper-containing oxide may be present in the copper-containing glasses in an amount of about 20 mol %, about 25 mol %, about 30 mol %, or about 35 mol %. The copper-containing oxide may include CuO, Cu₂O and/or combinations thereof.

The copper-containing oxides in the copper-containing glasses form the Cu¹⁺ ions present in the resulting glass. Copper may be present in the glass composition and/or the glasses including the glass composition in various forms including Cu⁰, Cu¹⁺, and Cu²⁺. It is believed that copper in the Cu⁰ or Cu¹⁺ forms provide biocidal activity. However, forming and maintaining these states of biocidal copper can be challenging and often, in known glass compositions, Cu²⁺ ions are formed instead of the desired Cu⁰ or Cu¹⁺ ions.

The amount of copper-containing oxide in the copper-containing glasses may be greater than the amount of Al₂O₃ in the glass composition. Without wishing to be bound by theory it is believed that an about equal amount of copper-containing oxides and Al₂O₃ in the glass composition results in the formation of tenorite (CuO) instead of cuprite (Cu₂O). The presence of tenorite decreases the amount of Cu¹⁺ in favor of Cu²⁺ and thus leads to reduced biocidal activity. Moreover, when the amount of copper-containing oxides is about equal to the amount of Al₂O₃, aluminum prefers to be in a four-fold coordination and the copper in the glass composition and resulting glass remains in the Cu²⁺ form so that the charge remains balanced. Where the amount of copper-containing oxide exceeds the amount of Al₂O₃, then it is believed that at least a portion of the copper is free to remain in the Cu¹⁺ state, instead of the Cu²⁺ state, and thus the presence of Cu¹⁺ ions increases.

The copper-containing glasses may also include P₂O₅ in an amount, in mole percent, in the range of from about 0 to about 25, from about 0 to about 22, from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1, from about 0.4 to about 1, from about 0.5 to about 1, from about 0 to about 0.5, from about 0 to about 0.4, from about 0 to about 0.3, from about 0 to about 0.2, from about 0 to about 0.1, and all ranges and sub-ranges therebetween. In some embodiments, the glass composition includes about 10 mol % or about 5 mol % P₂O₅ or, alternatively, may be substantially free of P₂O₅.

The P₂O₅ in the copper-containing glass particles may form at least part of a less durable phase or a degradable phase in the glass. The relationship between the degradable phase(s) of the glass and biocidal activity is discussed in greater detail herein. According to embodiments of the present disclosure, the amount of P₂O₅ may be adjusted to control crystallization of the glass composition and/or glass during forming. For example, when the amount of P₂O₅ is limited to about 5 mol % or less or even 10 mol % or less, crystallization may be minimized or controlled to be uniform. However, the amount or uniformity of crystallization of the glass composition and/or glass may not be of concern and thus, the amount of P₂O₅ utilized in the glass composition may be greater than 10 mol %.

Optionally, the amount of P₂O₅ in the glass composition may be adjusted based on the desired damage resistance of the glass, despite the tendency for P₂O₅ to form a less durable phase or a degradable phase in the glass. Without wishing to be bound by theory, P₂O₅ can decrease the melting viscosity relative to SiO₂. In some instances, P₂O₅ is believed to help suppress zircon breakdown viscosity (e.g., the viscosity at which zircon breaks down to form ZrO₂) and may be more effective in this regard than SiO₂. When glass is to be chemically strengthened via an ion exchange process, P₂O₅ can improve the diffusivity and decrease ion exchange times, when compared to other components that are sometimes characterized as network formers (e.g., SiO₂ and/or B₂O₃).

In some aspects, the copper-containing glass particles can be formed from a glass composition that includes B₂O₃ in an amount, in mole percent, in the range of from about 0 to about 25, from about 0 to about 22, from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1, from about 0.4 to about 1, from about 0.5 to about 1, from about 0 to about 0.5, from about 0 to about 0.4, from about 0 to about 0.3, from about 0 to about 0.2, from about 0 to about 0.1, and all ranges and sub-ranges therebetween. In some embodiments, the copper-containing glass particles include a non-zero amount of B₂O₃, which may be, for example, about 10 mol % or about 5 mol %. The copper-containing glass particles of some embodiments may be substantially free of B₂O₃.

In one or more embodiments, B₂O₃ forms a less durable phase or a degradable phase in the glass formed from the glass composition. The relationship between the degradable phase(s) of the glass and biocidal activity is discussed in greater detail herein. Without being bound by theory, it is believed the inclusion of B₂O₃ in glass compositions may impart damage resistance in glasses incorporating such glass compositions, despite the tendency for B₂O₃ to form a less durable phase or a degradable phase in the glass. In some aspects, the copper-containing glass particles can include one or more alkali oxides (R₂O) (e.g., Li₂O, Na₂O, K₂O, Rb₂O and/or Cs₂O). In some aspects, the alkali oxides modify the melting temperature and/or liquidus temperatures of such glass compositions. In one or more aspects, the amount of alkali oxides may be adjusted to provide a glass composition exhibiting a low melting temperature and/or a low liquidus temperature. Without being bound by theory, the addition of alkali oxide(s) may increase the coefficient of thermal expansion (CTE) and/or lower the chemical durability of the copper-containing glass particles that include such glass compositions. In some cases these attributes may be altered by the addition of alkali oxide(s).

In some aspects, the copper-containing glasses used to form the copper-containing glass particles disclosed herein may be chemically strengthened via an ion exchange process in which the presence of a small amount of alkali oxide (such as Li₂O and Na₂O) is required to facilitate ion exchange with larger alkali ions (e.g., K⁺), for example exchanging smaller alkali ions from a copper-containing glass with larger alkali ions from a molten salt bath containing such larger alkali ions.

In some aspects, the glass composition used to form the copper-containing glass particles includes K₂O in an amount in the range of from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1, from about 0.4 to about 1, from about 0.5 to about 1, from about 0 to about 0.5, from about 0 to about 0.4, from about 0 to about 0.3, from about 0 to about 0.2, from about 0 to about 0.1 and all ranges and sub-ranges therebetween. In some embodiments, the glass composition includes a non-zero amount of K₂O or, alternatively, the glass composition may be substantially free, as defined herein, of K₂O. In addition to facilitating ion exchange, where applicable, in one or more embodiments, K₂O can also form a less durable phase or a degradable phase in the glass formed form the glass composition. The relationship between the degradable phase(s) of the glass and biocidal activity is discussed in greater detail herein.

In one or more embodiments, the glass composition includes Na₂O in an amount in the range of from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1, from about 0.4 to about 1, from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the glass composition includes a non-zero amount of Na₂O or, alternatively, the glass composition may be substantially free, as defined herein, of Na₂O.

In one or more embodiments, the glass composition may include one or more divalent cation oxides, such as alkaline earth oxides and/or ZnO. Such divalent cation oxides may be included to improve the melting behavior of the glass compositions. With respect to ion exchange performance, the presence of divalent cations can act to decrease alkali mobility and thus, when larger divalent cation oxides are utilized, there may be a negative effect on ion exchange performance. Furthermore, smaller divalent cation oxides generally help the compressive stress developed in an ion-exchanged glass more than the larger divalent cation oxides. Hence, divalent cation oxides such as MgO and ZnO can offer advantages with respect to improved stress relaxation, while minimizing the adverse effects on alkali diffusivity.

In one or more embodiments, the glass composition includes CaO in an amount, in mole percent, in the range of from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1, from about 0.4 to about 1, from about 0.5 to about 1, from about 0 to about 0.5, from about 0 to about 0.4, from about 0 to about 0.3, from about 0 to about 0.2, from about 0 to about 0.1 and all ranges and sub-ranges therebetween. In some embodiments, the glass composition is substantially free of CaO.

In one or more embodiments, the glass composition includes MgO in an amount, in mole percent, in the range of from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1, from about 0.4 to about 1, from about 0.5 to about 1, from about 0 to about 0.5, from about 0 to about 0.4, from about 0 to about 0.3, from about 0 to about 0.2, from about 0 to about 0.1, and all ranges and sub-ranges therebetween. In some embodiments, the glass composition is substantially free of MgO.

The glass composition of one or more embodiments may include ZnO in an amount, in mole percent, in the range of from about 0 to about 5, from about 0 to about 4, from about 0 to about 3, from about 0 to about 2, from about 0 to about 1, from about 0.1 to about 1, from about 0.2 to about 1, from about 0.3 to about 1, from about 0.4 to about 1, from about 0.5 to about 1, from about 0 to about 0.5, from about 0 to about 0.4, from about 0 to about 0.3, from about 0 to about 0.2, from about 0 to about 0.1, and all ranges and sub-ranges therebetween. In some embodiments, the glass composition is substantially free of ZnO. The glass composition of one or more embodiments may include Fe₂O₃, in mole percent, in the range of from about 0 to about 5, from about 0 to about 4, from about 0 to about 3, from about 0 to about 2, from about 0 to about 1, from about 0.1 to about 1, from about 0.2 to about 1, from about 0.3 to about 1, from about 0.4 to about 1, from about 0.5 to about 1, from about 0 to about 0.5, from about 0 to about 0.4, from about 0 to about 0.3, from about 0 to about 0.2, from about 0 to about 0.1, and all ranges and sub-ranges therebetween.

In some embodiments, the glass composition is substantially free of Fe₂O₃.

In one or more embodiments, the glass composition may include one or more colorants. Examples of such colorants include NiO, TiO₂, Fe₂O₃, Cr₂O₃, CO₃O₄ and other known colorants. In some embodiments, the one or more colorants may be present in an amount in the range up to about 10 mol %. In some instances, the one or more colorants may be present in an amount in the range of from about 0.01 mol % to about 10 mol %, from about 1 mol % to about 10 mol %, from about 2 mol % to about 10 mol %, from about 5 mol % to about 10 mol %, from about 0.01 mol % to about 8 mol %, or from about 0.01 mol % to about 5 mol %.

In one or more embodiments, the glass composition may include one or more nucleating agents. Exemplary nucleating agents include TiO₂, ZrO₂ and other known nucleating agents in the art. The glass composition can include one or more different nucleating agents. The nucleating agent content of the glass composition may be in the range from about 0.01 mol % to about 1 mol %. In some instances, the nucleating agent content may be in the range from about 0.01 mol % to about 0.9 mol %, from about 0.01 mol % to about 0.8 mol %, from about 0.01 mol % to about 0.7 mol %, from about 0.01 mol % to about 0.6 mol %, from about 0.01 mol % to about 0.5 mol %, from about 0.05 mol % to about 1 mol %, from about 0.1 mol % to about 1 mol %, from about 0.2 mol % to about 1 mol %, from about 0.3 mol % to about 1 mol %, or from about 0.4 mol % to about 1 mol %, and all ranges and sub-ranges therebetween.

The copper-containing glasses formed from the glass compositions may include a plurality of Cu¹⁺ ions. In some embodiments, such Cu¹⁺ ions form part of the glass network and may be characterized as a glass modifier. Without being bound by theory, where Cu¹⁺ ions are part of the glass network, it is believed that during typical glass formation processes, the cooling step of the molten glass occurs too rapidly to allow crystallization of the copper-containing oxide (e.g., CuO and/or Cu₂O). Thus the Cu¹⁺ remains in an amorphous state and becomes part of the glass network. In some cases, the total amount of Cu¹⁺ ions, whether they are in a crystalline phase or in the glass matrix, may be even higher, such as up to 40 mol %, up to 50 mol %, or up to 60 mol %.

In one or more embodiments, the copper-containing glasses formed from the glass compositions disclosed herein include Cu¹⁺ ions that are dispersed in the glass matrix as Cu¹⁺ crystals. In one or more embodiments, the Cu¹⁺ crystals may be present in the form of cuprite. The cuprite present in the copper-containing glass may form a cuprite phase that is distinct from the glass matrix or glass phase. In other embodiments, the cuprite phase may form part of or may be associated with one or more glass phases (e.g., the durable phase described herein). Thus, in some aspects, Cu⁺¹ ions may be present in one or both of the cuprite phase and/or the glass phase. The Cu¹⁺ crystals may have an average major dimension of about 5 micrometers (μm) or less, 4 micrometers (μm) or less, 3 micrometers (μm) or less, 2 micrometers (μm) or less, about 1.9 micrometers (μm) or less, about 1.8 micrometers (μm) or less, about 1.7 micrometers (μm) or less, about 1.6 micrometers (μm) or less, about 1.5 micrometers (μm) or less, about 1.4 micrometers (μm) or less, about 1.3 micrometers (μm) or less, about 1.2 micrometers (μm) or less, about 1.1 micrometers or less, 1 micrometers or less, about 0.9 micrometers (μm) or less, about 0.8 micrometers (μm) or less, about 0.7 micrometers (μm) or less, about 0.6 micrometers (μm) or less, about 0.5 micrometers (μm) or less, about 0.4 micrometers (μm) or less, about 0.3 micrometers (μm) or less, about 0.2 micrometers (μm) or less, about 0.1 micrometers (μm) or less, about 0.05 micrometers (μm) or less, and all ranges and sub-ranges therebetween. As used herein and with respect to the phrase “average major dimension”, the word “average” refers to a mean value and the word “major dimension” is the greatest dimension of the particle as measured by SEM. In some embodiments, the cuprite phase may be present in the copper-containing glass in an amount of at least about 10 wt %, at least about 15 wt %, at least about 20 wt %, at least about 25 wt %, and all ranges and subranges therebetween of the copper-containing glass. In some aspects, the glass phase is present in an amount by weight that is greater than the cuprite phase.

In some embodiments, the copper-containing glass may include about 70 wt % Cu¹⁺ or more and about 30 wt % of Cu²⁺ or less. The Cu²⁺ ions may be present in tenorite form and/or even in the glass (e.g., not as a crystalline phase).

In some embodiments, the total amount of Cu, by weight percent (wt %), in the copper-containing glass may be in the range of from about 10 to about 30, from about 15 to about 25, from about 11 to about 30, from about 12 to about 30, from about 13 to about 30, from about 14 to about 30, from about 15 to about 30, from about 16 to about 30, from about 17 to about 30, from about 18 to about 30, from about 19 to about 30, from about 20 to about 30, from about 10 to about 29, from about 10 to about 28, from about 10 to about 27, from about 10 to about 26, from about 10 to about 25, from about 10 to about 24, from about 10 to about 23, from about 10 to about 22, from about 10 to about 21, from about 10 to about 20, from about 16 to about 24, from about 17 to about 23, from about 18 to about 22, from about 19 to about 21, and all ranges and sub-ranges therebetween. In one or more embodiments, the ratio of Cu¹⁺ ions to the total amount of Cu in the copper-containing glass is about 0.5 or greater, 0.55 or greater, 0.6 or greater, 0.65 or greater, 0.7 or greater, 0.75 or greater, 0.8 or greater, 0.85 or greater, 0.9 or greater or even 1 or greater, and all ranges and sub-ranges therebetween. The amount of Cu and the ratio of Cu¹⁺ ions to total Cu may be determined by inductively coupled plasma (ICP) techniques known in the art.

In some embodiments, the copper-containing glass may exhibit a greater amount of Cu¹⁺ and/or Cu⁰ than Cu²⁺. For example, based on the total amount of Cu¹⁺, Cu²⁺ and Cu⁰ in the glasses, the percentage of Cu¹⁺ and Cu⁰, combined, may be in the range of from about 50% to about 99.9%, from about 50% to about 99%, from about 50% to about 95%, from about 50% to about 90%, from about 55% to about 99.9%, from about 60% to about 99.9%, from about 65% to about 99.9%, from about 70% to about 99.9%, from about 75% to about 99.9%, from about 80% to about 99.9%, from about 85% to about 99.9%, from about 90% to about 99.9%, from about 95% to about 99.9%, and all ranges and sub-ranges therebetween. The relative amounts of Cu¹⁺, Cu²⁺ and Cu⁰ may be determined using x-ray photoluminescence spectroscopy (XPS) techniques known in the art. The copper-containing glass can include at least a first phase and second phase. In one or more embodiments, the copper-containing glass may include two or more phases wherein the phases differ based on the ability of the atomic bonds in the given phase to withstand interaction with a leachate. Specifically, the copper-containing glass of one or more embodiments may include a first phase that may be described as a degradable phase and a second phase that may be described as a durable phase. The phrases “first phase” and “degradable phase” may be used interchangeably. The phrases “second phase” and “durable phase” may be used interchangeably. As used herein, the term “durable” refers to the tendency of the atomic bonds of the durable phase to remain intact during and after interaction with a leachate. As used herein, the term “degradable” refers to the tendency of the atomic bonds of the degradable phase to break during and after interaction with one or more leachates. Durable and degradable are relative terms, meaning that there is no explicit degradation rate above which a phase is durable and below which a phase is degradable, but rather, the durable phase is more durable than the degradable phase.

In one or more embodiments, the durable phase includes SiO₂ and the degradable phase includes at least one of B₂O₃, P₂O₅ and R₂O (where R can include any one or more of K, Na, Li, Rb, and Cs). Without wishing to be bound by theory, it is believed that the components of the degradable phase (e.g., B₂O₃, P₂O₅ and/or R₂O) more readily interact with a leachate and the bonds between these components to one another and to other components in the copper-containing glass more readily break during and after the interaction with the leachate. Leachates may include water, acids or other similar materials. In one or more embodiments, the degradable phase withstands degradation for 1 week or longer, 1 month or longer, 3 months or longer, or even 6 months or longer. In some embodiments, longevity may be characterized as maintaining biocidal efficacy over a specific period of time.

In one or more embodiments, the durable phase is present in an amount by weight that is greater than the amount of the degradable phase. In some instances, the degradable phase forms islands and the durable phase forms the sea surrounding the islands (e.g., the durable phase). In one or more embodiments, either one or both of the durable phase and the degradable phase may include cuprite. The cuprite in such embodiments may be dispersed in the respective phase or in both phases.

In some embodiments, phase separation occurs without any additional heat treatment of the copper-containing glass. In some embodiments, phase separation may occur during melting and may be present when the glass composition is melted at temperatures up to and including about 1600° C. or 1650° C. When the glass is cooled, the phase separation is maintained.

In one or more embodiments, the copper-containing glass may be formed using low cost melting tanks that are typically used for melting glass compositions such as soda lime silicate. The copper-containing glass may be formed into a sheet using forming processes known in the art. Example forming methods include float glass processes and down-draw processes such as fusion draw and slot draw. After formation, the copper-containing glass may be formed into sheets and may be shaped, polished or otherwise processed for a desired end use. In some instances, the copper-containing glass may be ground to a powder or particulate form to form the copper-containing glass particles.

According to some embodiments of the present disclosure, the copper-containing particles and/or materials described herein leach the copper ions when exposed or in contact with a leachate. In one or more embodiments, the copper-containing particles leach only copper ions when exposed to leachates including water.

According to embodiments of the present disclosure, the biocidal materials containing copper-containing glass particles described herein may have a tunable biocidal activity release. The biocidal activity of the copper-containing glass particles may be caused by contact between the copper-containing particles and a leachate, such as water, where the leachate causes Cu¹⁺ ions to be released from the copper-containing particles. This action may be described as water solubility and the water solubility can be tuned to control the release of the Cu⁺¹ ions.

In some embodiments, where the Cu¹⁺ ions are disposed in the glass network and/or form atomic bonds with the atoms in the glass network, water or humidity breaks those bonds and the Cu¹⁺ ions available for release and may be exposed on the glass or glass ceramic surface.

In one or more embodiments, the copper-containing particles may have a diameter in the range from about 0.1 micrometers (μm) to about 10 micrometers (μm), from about 0.1 micrometers (μm) to about 9 micrometers (μm), from about 0.1 micrometers (μm) to about 8 micrometers (μm), from about 0.1 micrometers (μm) to about 7 micrometers (μm), from about 0.1 micrometers (μm) to about 6 micrometers (μm), from about 0.5 micrometers (μm) to about 10 micrometers (μm), from about 0.75 micrometers (μm) to about 10 micrometers (μm), from about 1 micrometers (μm) to about 10 micrometers (μm), from about 2 micrometers (μm) to about 10 micrometers (μm), from about 3 micrometers (μm) to about 10 micrometers (μm) from about 3 micrometers (μm) to about 6 micrometers (μm), from about 3.5 micrometers (μm) to about 5.5 micrometers (μm), from about 4 micrometers (μm), to about 5 micrometers (μm), and all ranges and sub-ranges therebetween. As used herein, the term “diameter” refers to the longest dimension of the particle. The particulate copper-containing glass may be substantially spherical or may have an irregular shape. The particles may be provided in a solvent and thereafter dispersed in a carrier as otherwise described herein.

According to an aspect of the present disclosure, the organic co-biocide can be selected from isothiazolinones, bicyclic oxazolidines, bromine nitrogen-based compounds, or combinations thereof. In some aspects, the organic co-biocide(s) and the copper-containing glass particles are combined in an amount such that a ratio of the amount of organic co-biocide(s) to the amount of copper-containing glass particles provides biocidal synergy. As used herein, when the amount of organic co-biocide(s) is decreased and replaced with a corresponding amount (by weight) of copper-containing glass particles without a decrease in biocidal efficacy, as measured by comparing the MBC of the organic co-biocide(s) with the MBC of the combination of organic co-biocide and copper-containing glass particles, the combination of organic co-biocide(s) and copper-containing glass particles is considered to exhibit biocidal synergy.

In some aspects, a decrease in the minimum bactericidal concentration (MBC) of a combination of the copper-containing glass particles and the organic co-biocides compared to the MBC of the organic co-biocide alone (e.g., in the absence of the copper-containing glass particles) is used as an indication of biocidal synergy. For example, the combination or organic co-biocide(s) and copper-containing glass particles may be considered to exhibit biocidal synergy when the MBC of the combination of the organic co-biocide(s) and the copper-containing glass particles is less than an MBC of the organic co-biocide(s) in the absence of the copper-containing glass particles. In some examples, the MBC of the combination of the organic co-biocide(s) and the copper-containing glass particles may be less than the MBC of the organic co-biocide(s) in the absence of the copper-containing glass particles by at least 40%. For example, the MBC of the combination of the organic co-biocide(s) and the copper-containing glass particles may be less than the MBC of the organic co-biocide(s) in the absence of the copper-containing glass particles by at least about 40%, at least about 50%, at least about 60%, or at least about 70%. In some examples, the MBC of the combination of the organic co-biocide(s) and the copper-containing glass particles may be less than the MBC of the organic co-biocide(s) in the absence of the copper-containing glass particles by from about 40% to about 80%, about 40% to about 75%, about 40% to about 70%, about 40% to about 65%, about 40% to about 60%, about 40% to about 55%, about 40% to about 50%, about 45% to about 80%, about 45% to about 75%, about 45% to about 70%, about 45% to about 65%, about 45% to about 60%, about 45% to about 55%, about 45% to about 50%, about 50% to about 80%, about 50% to about 75%, about 50% to about 70%, about 50% to about 65%, about 50% to about 60%, about 50% to about 55%, about 55% to about 80%, about 55% to about 75%, about 55% to about 70%, about 55% to about 65%, about 55% to about 60%, about 60% to about 80%, about 60% to about 75%, about 60% to about 70%, or about 70% to about 80%.

In some aspects, a ratio of the amount of organic co-biocide(s) to the amount of copper-containing glass particles (in weight percent) can be in the range of from about 3:1 to about 1:3. For example, the ratio of the amount of organic co-biocide(s) to the amount of copper-containing glass particles (in weight percent) can be in the range of from about 3:1 to about 1:3, about 2.5:1 to about 1:3, about 2:1 to about 1:3, about 1.5:1 to about 1:3, about 1:1 to about 1:3, about 3:1 to about 1:2, about 2.5:1 to about 1:2, about 2:1 to about 1:2, about 1.5:1 to about 1:2, or about 1:1 to about 1:2.

In some aspects, the organic co-biocide can include a single isothiazolinone or a combination of isothiazolinones. Non-limiting examples of suitable isothiazolinones include benzisothiazolinone (BIT), octylisothiazolinone (OIT), methylisothiazolinone (MIT), methylchloroisothiazolinone (CMIT).

In some aspects, the organic co-biocide can include a single bicyclic oxazolidine or a combination of bicyclic oxazolidines. Non-limiting examples of suitable bicyclic oxazolidines include 5-hydroxymethyl-1-aza-3,7-dioxabicyclo-(3.3.0) octane, 5-hydroxymethoxymethyl-1-aza-3,7-dioxabicyclo-(3.3.0) octane, and 5-hydroxypoly(methyleneoxy)methyl-1-aza-3,7-dioxabicyclo-(3.3.0) octane. For example, the organic co-biocide can include a combination of 5-hydroxymethyl-1-aza-3,7-dioxabicyclo-(3.3.0) octane, 5-hydroxymethoxymethyl-1-aza-3,7-dioxabicyclo-(3.3.0) octane, and 5-hydroxypoly(methyleneoxy)methyl-1-aza-3,7-dioxabicyclo-(3.3.0) octane. One example of a suitable organic co-biocide is Nuosept® 95 Preservative (available from Troy Chemical Corporation, USA), which contains a mixture of 5-hydroxymethyl-1-aza-3,7-dioxabicyclo-(3.3.0) octane, 5-hydroxymethoxymethyl-1-aza-3,7-dioxabicyclo-(3.3.0) octane, and 5-hydroxypoly(methyleneoxy)methyl-1-aza-3,7-dioxabicyclo-(3.3.0) octane. Unless expressly noted otherwise herein, all references to “Nuosept® 95” in this disclosure are for an organic co-biocide with the following composition: 5-hydroxymethyl-1-aza-3,7-dioxabicyclo-(3.3.0) octane (28.80 wt %), 5-hydroxymethoxymethyl-1-aza-3,7-dioxabicyclo-(3.3.0) octane (16.00 wt %), 5-hydroxypoly(methyleneoxy(74% C2, 21 C3, 4% C4, 1% C5))methyl-1-aza-3,7-dioxabicyclo-(3.3.0) octane (5.20 wt %), with the remainder inactive ingredients (50.00 wt %).

In some aspects, the organic co-biocide can include a single bromine nitrogen-based compound or a combination of bromine nitrogen-based compounds. In one example, the bromine nitrogen-based compound is 2-bromo-2-nitro-1,3-propanediol.

In some aspects, the biocidal material can include a carrier, examples of which may include polymers, monomers, binders, solvents, or a combination thereof. In one example, the carrier can be a paint that is used for application to a surface. The paint can be a dispersion of finely divided solids in a liquid medium (e.g., water, organic solvent, and/or inorganic solvent) that can be applied to a surface to form a film that adheres to the surface. Examples of solids used in paints include pigments, fillers, extenders, driers, rheology modifiers, etc. In some examples, the paint can be a latex paint. Examples of solvent include water and organic solvents.

In some embodiments, for example, when the carrier is in the form of a paint or coating, the polymer may be selected from acrylates, acrylic aliphatic urethanes, acrylic aromatic urethanes, alkyds, asphalt, bitumen, pitch, cationic polymers, cellulose-based polymers, chlorinated rubber, drying oil, epoxy, nitrocellulose, phenolic polymers, resins, plastisol, polyolefin dispersions, polyurethane, powdered coatings, p-vinyl butyral, saturated polyesters, shellac, silicate, silicone, silyl modified PU (SPUR), styrene, unsaturated polyester, urea, enzoguanamine, melamine resins, vinyl alkylate, vinyl chloride, vinyl fluoride, vinylidene chloride, vinylidene fluoride, and combinations thereof. The carrier may include polymers and/or monomers in the absence of a solvent or in combination with a solvent. In other embodiments, the polymers may be dissolved in a solvent or dispersed as a separate phase in a solvent and form a polymer emulsion, such as a latex (which is a water emulsion of a synthetic or natural rubber, or plastic obtained by polymerization, and used especially in coatings as paint and adhesives). Polymers may include fluorinated silanes or other low friction or anti-frictive materials. The polymers can contain impact modifiers, flame retardants, UV inhibitors, antistatic agents, mold release agents, fillers including glass, metal or carbon fibers or particles (including spheres), talc, clay or mica and colorants. Specific examples of monomers include catalyst curable monomers, thermally-curable monomers, radiation-curable monomers, and combinations thereof.

In some aspects, the carrier is a film-forming component that forms a film that adheres to a surface to which the material is applied. For example, the biocidal material can be combined with a film-forming component to form a biocidal paint. Non-limiting examples of film-forming components, include from polystyrenes, high impact polystyrenes, polycarbonates, nylon, polyamides, poly(acrylonitrile-butadiene-styrene), polycarbonate-poly(acrylonitrile-butadiene-styrene) blends, polybutylene terephthalate, polybutylene terephthalate co-polymers, polyethylene terephthalate, polyethylene terephthalate co-polymers, polyolefins, polyethylenes, polypropylenes, cyclic polyolefins, modified polyphenylene oxide, polyvinylchloride, acrylic polymers, polymethyl methacrylate, thermoplastic elastomers, thermoplastic urethanes, styrene acrylic polymers, alkyd emulsions, vinyl acetate polymers, vinyl alkylate co-polymers, vinyl acetate-acrylic acid co-polymers, vinyl acetate-ethylene co-polymers, and polyetherimides, and combinations thereof.

To improve processability, mechanical properties and interactions between the carrier and the copper-containing glass particles described herein (including any fillers and/or additives that may be used), processing agents/aids may be included in the articles described herein. Exemplary processing agents/aids can include solid or liquid materials. The processing agents/aids may provide various extrusion benefits, and may include silicone based oil, wax, and free flowing fluoropolymer. In other embodiments, the processing agents/aids may include compatibilizers/coupling agents, e.g., organosilicon compounds such as organo-silanes/siloxanes that are typically used in processing of polymer composites for improving mechanical and thermal properties. Such compatibilizers/coupling agents can be used to surface modify the glass and can include (3-acryloxy-propyl)trimethoxysilane; N-(2-aminoethyl)-3-aminopropyltrimethoxysilane; 3-aminopropyltri-ethoxysilane; 3-aminopropyltrimethoxysilane; (3-glycidoxypropyl)trimethoxysilane; 3-mercapto-propyltrimethoxysilane; 3-methacryloxypropyltrimethoxysilane; and vinyltrimethoxysilane.

In some embodiments, the materials described herein may include fillers including pigments, that are typically metal based inorganics and can also be added for color and other purposes, e.g., aluminum pigments, copper pigments, cobalt pigments, manganese pigments, iron pigments, titanium pigments, tin pigments, clay earth pigments (naturally formed iron oxides), carbon pigments, antimony pigments, barium pigments, and zinc pigments.

The amount of the biocidal material according to the present disclosure utilized in a given application may be based at least in part on the desired level of biocidal efficacy and the intended application. For example, the biocidal material used as an in-can preservative may depend on factors such as the desired level of biocidal efficacy, the other components present, and the desired length of preservative effect, etc. The amount of the biocidal material used as an in-can preservative in a water-based paint may be different than the amount of biocidal material used as an in-can preservative in a non-aqueous based paint.

Without wishing to be limited by any theory, it is believed that the synergistic effect between the organic co-biocide(s) and the copper-containing glass particles may be at least partially attributable to stabilization of the organic co-biocide by copper. The synergistic effect may result in a sustained minimum level of efficacy for a longer period of time than would be seen with either the organic co-biocide or copper-containing glass particles individually. This extended level of efficacy may provide a longer in-can preservative effect for the biocidal material of the present disclosure. The increase in efficacy exhibited by the combination of the organic co-biocide and copper-containing glass particles, as measured by MBC, is more than what would be expected for an additive effect, indicative of a biocidal synergy between the organic co-biocide and copper-containing glass particles. The biocidal material of the present disclosure can be cost effective compared to the use of individual biocides because lower amounts of both the organic co-biocide(s) and the copper-containing glass particles exhibit the same or an improved biocidal effect compared to the individual biocides.

### EXAMPLES

Embodiments of the present disclosure are further described below with respect to certain exemplary and specific embodiments thereof, which are illustrative only and not intended to be limiting.

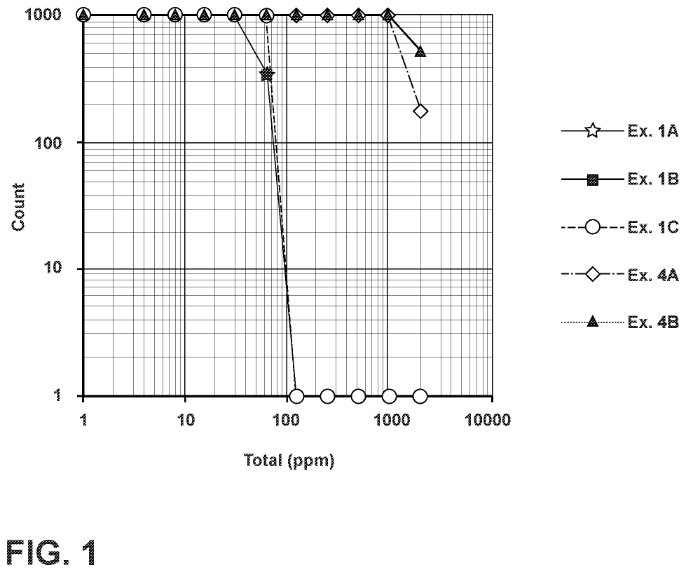

The MBC values for Examples 1A-C, 2A-C, 3A-C, and 4A-B were measured as described above using P. aeruginosa and the results are shown in Table 1 below and in FIGS. 1-3. The number of colonies remaining after treatment was determined for serial dilutions of 3 different organic biocides alone and in combination with copper-containing glass particles. Example 1A was treated with serial dilutions of Nuosept® 95 Preservative, which contains a mixture of 5-hydroxymethyl-1-aza-3,7-dioxabicyclo-(3.3.0) octane, 5-hydroxymethoxymethyl-1-aza-3,7-dioxabicyclo-(3.3.0) octane, and 5-hydroxypoly(methyleneoxy)methyl-1-aza-3,7-dioxabicyclo-(3.3.0) octane. Examples 1B and 1C were treated with serial dilutions of a 50:50 mixture and a 25:75 mixture, respectively, of Nuosept® 95 Preservative and copper-containing glass particles. Example 2A was treated with serial dilutions of benzisothiazolinone (BIT). Examples 2B and 2C were treated with serial dilutions of a 50:50 mixture and a 25:75 mixture, respectively, of BIT and copper-containing glass particles. Example 3A was treated with serial dilutions of Bronopol. Examples 3B and 3C were treated with serial dilutions of a 50:50 mixture and a 25:75 mixture, respectively, of Bronopol and copper-containing glass particles. Examples 4A and 4B were duplicate samples treated with serial dilutions of the copper-containing glass particles.

For each Example 1A-C, 2A-C, 3A-C, and 4A-B, 1000 μL of the dispersion of interest, the stock organic co-biocide dispersion, the stock copper-containing glass particle dispersion, or the indicated ratio of each dispersion, was added to a microcentrifuge tube (referred to as “tube 1”). 500 μL of the dispersion from tube 1 was diluted with 500 μL of thickened Letheen Broth (“tube 2”). Serial dilutions with thickened Letheen Broth were prepared up to tube 10. Tube 11 contained 500 μL of thickened Letheen Broth as a “broth blank.” 50 μL of P. aeruginosa was transferred directly from culture into each of tubes 1-11 and the tubes were incubated at 37° C. for 24 hours. At the end of the incubation period, each tube 1-11 was plated and the plates were incubated 37° C. for 24 hours. At the end of the incubation period, the plates were removed and the colonies on each plate were counted and recorded. In Table 1, the colony counts are shown in parentheses. The symbol “−” indicates that no bacteria was observed on the plates, the symbol “+” indicates that a trace of contamination was observed (<10 colonies), the symbol “++” indicates light contamination was observed (>100 colonies), and the symbol “+++” indicates heavy contamination was observed (continuous smear of growth). The copper-containing glass particles are abbreviated in Table 1 as “Cu.”

TABLE 1
MBC Observations for Examples 1A-1K

| | Biocide | Ex. 1A | Ex. 1B 50:50 | Ex. 1C 25:75 | | Ex. 2B | Ex. 2C |
|---|---|---|---|---|---|---|---|
| | Conc. | Nuosept ® | Nuosept ® | Nuosept ® | Ex. 2A | 50:50 | 25:75 |
| Tube | (ppm) | 95 | 95:Cu | 95:Cu | BIT | BIT:Cu | BIT:Cu |
| 1 | 2000 | −(0) | −(0) | −(0) | −(0) | −(0) | −(0) |
| 2 | 1000 | −(0) | −(0) | −(0) | −(0) | −(0) | −(0) |
| 3 | 500 | −(0) | −(0) | −(0) | −(0) | −(0) | −(0) |
| 4 | 250 | −(0) | −(0) | −(0) | −(0) | −(0) | −(0) |
| 5 | 125 | −(0) | −(0) | −(0) | −(0) | −(0) | −(0) |
| 6 | 62.5 | ++(344) | +++(>1000) | +++(>1000) | +(35) | +(37) | ++(700) |
| 7 | 31.25 | +++ | +++(>1000) | +++(>1000) | ++(513) | ++(625) | +++ |
| | | (>1000) | | | | | (>1000) |
| 8 | 15.63 | +++ | +++(>1000) | +++(>1000) | +++ | +++ | +++ |
| | | (>1000) | | | (>1000) | (>1000) | (>1000) |
| 9 | 7.81 | +++ | +++(>1000) | +++(>1000) | +++ | +++ | +++ |
| | | (>1000) | | | (>1000) | (>1000) | (>1000) |
| 10 | 3.91 | +++ | +++(>1000) | +++(>1000) | +++ | +++ | +++ |
| | | (>1000) | | | (>1000) | (>1000) | (>1000) |
| 11 | 0 | +++ | +++(>1000) | +++(>1000) | +++ | +++ | +++ |
| | | (>1000) | | | (>1000) | (>1000) | (>1000) |

| | | | Ex. 3B | Ex. 3C | | |
|---|---|---|---|---|---|---|
| | Biocide | Ex. 3A | 50:50 | 25:75 | Ex. 4A | Ex. 4B |
| Tube | Conc. (ppm) | Bronopol | Bronopol:Cu | Bronopol:Cu | Cu | Cu |
| 1 | 2000 | −(0) | −(0) | −(0) | ++(181) | ++(518) |
| 2 | 1000 | −(0) | −(0) | −(0) | +++ | +++ |
| | | | | | (>1000) | (>1000) |
| 3 | 500 | −(0) | −(0) | −(0) | +++ | +++ |
| | | | | | (>1000) | (>1000) |
| 4 | 250 | −(0) | −(0) | −(0) | +++ | +++ |
| | | | | | (>1000) | (>1000) |
| 5 | 125 | −(0) | −(0) | −(0) | +++ | +++ |
| | | | | | (>1000) | (>1000) |
| 6 | 62.5 | −(0) | −(0) | −(0) | +++ | +++ |
| | | | | | (>1000) | (>1000) |
| 7 | 31.25 | −(0) | −(0) | −(0) | +++ | +++ |
| | | | | | (>1000) | (>1000) |
| 8 | 15.63 | −(0) | ++(566) | +++(>1000) | +++ | +++ |
| | | | | | (>1000) | (>1000) |
| 9 | 7.81 | +++ | +++(>1000) | +++(>1000) | +++ | +++ |
| | | (>1000) | | | (>1000) | (>1000) |
| 10 | 3.91 | +++ | +++(>1000) | +++(>1000) | +++ | +++ |
| | | (>1000) | | | (>1000) | (>1000) |
| 11 | 0 | +++ | +++(>1000) | +++(>1000) | +++ | +++ |
| | | (>1000) | | | (>1000) | (>1000) |

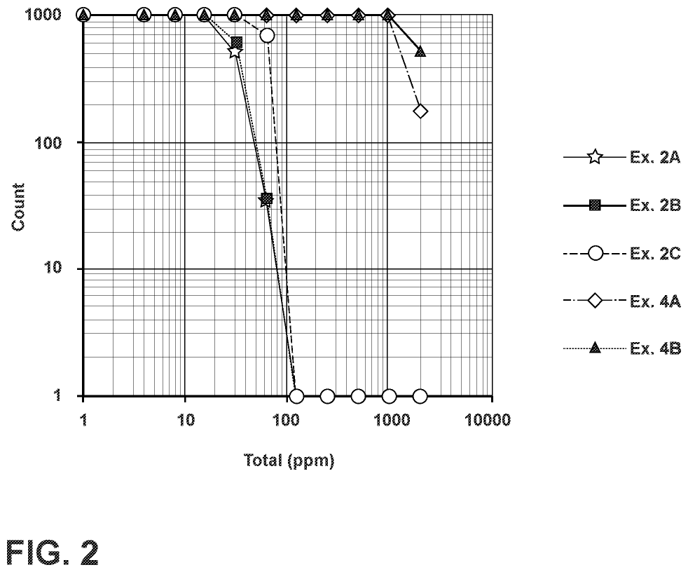

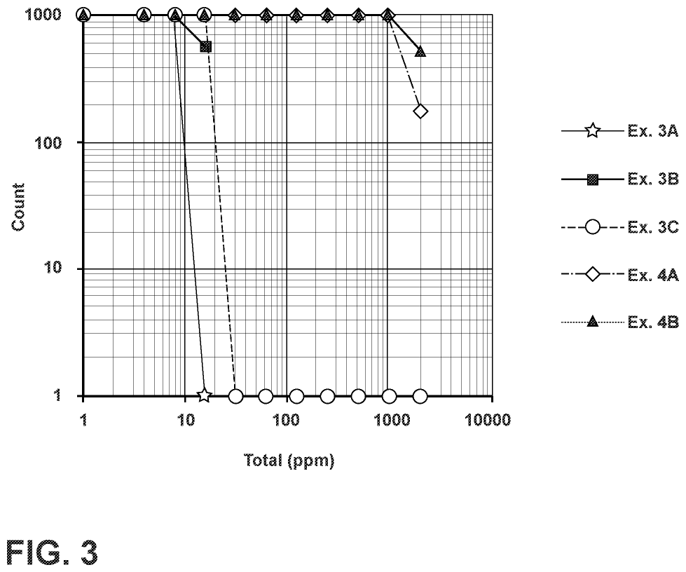

The results for the organic co-biocide Nuosept® 95 (Ex. 1A-C) and the copper-containing glass particles (Ex. 4A-B) are plotted in FIG. 1. The results for the organic co-biocide BIT (Ex. 2A-C) and the copper-containing glass particles (Ex. 4A-B) are plotted in FIG. 2. The results for the organic co-biocide Bronopol (Ex. 3A-C) and the copper-containing glass particles (Ex. 4A-B) are plotted in FIG. 3. The results from Table 1 show that the combination of the copper-containing glass particles with the organic co-biocide Nuosept® 95 (Ex. 1B and 1C), BIT (Ex. 2B and 2C), and Bronopol (Ex. 3B and 3C) significantly decreases the MBC of the respective organic co-biocide. For example, Ex. 1A shows that the MBC with Nuosept® 95 is 125 ppm. Ex. 1B and 1C show that as the amount of Nuosept® 95 is decreased and replaced with a corresponding amount of copper-containing glass particles the MBC in terms of total biocide concentration remains at 125 ppm, even when the concentration of Nuosept® 95 is decreased by 50% (Ex. 1B) and even when decreased by 75% (Ex. 1C). In other words, the organic co-biocide can be replaced with increasing amounts of the copper-containing glass particles to provide a total biocide concentration that achieves a similar MBC, but with less of the organic co-biocide. FIGS. 1-3 visually illustrate the effect of combining the organic co-biocide with the copper-containing glass particles on the MBC of the biocidal material. As can be seen in FIGS. 1-3, the biocidal material containing copper-containing glass particles alone (Ex. 4A-B) is not able to effectively kill 100% of the bacteria within the concentration ranges tested. However, when the copper-containing glass particles are combined with an organic co-biocide such as Nuosept® 95 (Ex. 1B-C), BIT (Ex. 2B-C), or Bronopol (Ex. 3B-C), less of the organic co-biocide is needed to achieve an MBC curve that is similar to that seen with each organic co-biocide alone (Ex. 1A, 2A, and 3A, respectively). These results suggest that the effect of the combination of the present organic co-biocides with the copper-containing glass particles is greater than an additive effect, indicating a synergistic biocidal effect.

The following non-limiting aspects are encompassed by the present disclosure. To the extent not already described, any one of the features of the first through the twenty-eighth aspect may be combined in part or in whole with features of any one or more of the other aspects of the present disclosure to form additional aspects, even if such a combination is not explicitly described.

According to a first aspect of the present disclosure, a biocidal material, comprises: a carrier; and a plurality of copper-containing glass particles; and at least one co-biocide selected from isothiazolinones, bicyclic oxazolidines, and bromine nitrogen-based compounds, and wherein a minimum bactericidal concentration (MBC) of a combination of the at least one co-biocide and the plurality of copper-containing glass particles is less than an MBC of the at least one co-biocide in the absence of the plurality of copper-containing glass particles, and wherein a ratio of the amount of the at least one co-biocide to the amount of copper-containing glass particles (in weight percent) is from about 3:1 to about 1:3.

According to a second aspect of the present disclosure, the biocidal material of aspect 1, wherein the MBC of the combination of the at least one co-biocide and the plurality of copper-containing glass particles is less than the MBC of the at least one co-biocide in the absence of the plurality of copper-containing glass particles by at least about 40%.

According to a third aspect of the present disclosure, the biocidal material of aspect 1 or aspect 2, wherein the co-biocide is an isothiazolinone selected from benzisothiazolinone (BIT), octylisothiazolinone (OTT), methylisothiazolinone (MIT), methylchloroisothiazolinone (CMIT), and combinations thereof.

According to a fourth aspect of the present disclosure, the biocidal material of any one of aspects 1-3, wherein the co-biocide is a bicyclic oxazolidine selected from 5-hydroxymethyl-1-aza-3,7-dioxabicyclo-(3.3.0) octane, 5-hydroxymethoxymethyl-1-aza-3,7-dioxabicyclo-(3.3.0) octane, 5-hydroxypoly(methyleneoxy)methyl-1-aza-3,7-dioxabicyclo-(3.3.0) octane, and combinations thereof.

According to a fifth aspect of the present disclosure, the biocidal material of any one of aspects 1-4, wherein the co-biocide is a bromine nitrogen-based compound, and wherein the bromine nitrogen-based compound is 2-bromo-2-nitro-1,3-propanediol.

According to a sixth aspect of the present disclosure, the biocidal material of any one of aspects 1-5, wherein the plurality of copper-containing glass particles contains a cuprite phase comprising a plurality of Cu¹⁺ ions, and comprises at least one of B₂O₃, P₂O₅, and R₂O, wherein R is an alkali metal selected from K, Na, Li, Rb, and Cs.

According to a seventh aspect of the present disclosure, the biocidal material of aspect 6, wherein the plurality of copper-containing glass particles further comprises a glass phase comprising more than 40 mol % SiO₂.

According to an eighth aspect of the present disclosure, the biocidal material of aspect 7, wherein the glass phase is present in an amount by weight greater than the cuprite phase.

According to a ninth aspect of the present disclosure, the biocidal material of aspect 7 or aspect 8, wherein the cuprite phase is dispersed in the glass phase.

According to a tenth aspect of the present disclosure, the biocidal material of any one of aspects 7-9, wherein either one or both of the cuprite phase and the glass phase comprise Cu¹⁺ ions.

According to an eleventh aspect of the present disclosure, the biocidal material of any one of aspects 6-10, wherein the cuprite phase comprises crystals having an average major dimension of about 0.5 micrometers (μm) or less.

According to a twelfth aspect of the present disclosure, the biocidal material of any one of aspects 6-11, wherein the cuprite phase is degradable and leaches in the presence of water.

According to a thirteenth aspect of the present disclosure, the biocidal material of any one of aspects 1-12, wherein the carrier comprises at least one of a polymer, monomer, binder, and solvent.

According to a fourteenth aspect of the present disclosure, the biocidal material of any one of aspects 1-13, wherein a ratio of an amount of the plurality of copper-containing glass particles to an amount of the at least one co-biocide provides biocidal synergy.

According to a fifteenth aspect of the present disclosure, the biocidal paint comprises: a film-forming component; a solvent; a plurality of copper-containing glass particles; and at least one co-biocide selected from isothiazolinones, bicyclic oxazolidines, and bromine nitrogen-based compounds, wherein a minimum bactericidal concentration (MBC) of a combination of the at least one co-biocide and the plurality of copper-containing glass particles is less than an MBC of the at least one co-biocide in the absence of the plurality of copper-containing glass particles, and wherein a ratio of the amount of the at least one co-biocide to the amount of copper-containing glass particles (in weight percent) is from about 3:1 to about 1:3.

According to a sixteenth aspect of the present disclosure, the biocidal paint of aspect 15, wherein the MBC of the combination of the at least one co-biocide and the plurality of copper-containing glass particles is less than the MBC of the at least one co-biocide in the absence of the plurality of copper-containing glass particles by at least about 40%.

According to a seventeenth aspect of the present disclosure, the biocidal paint of aspect 15 or aspect 16, wherein the co-biocide is an isothiazolinone selected from benzisothiazolinone (BIT), octylisothiazolinone (OIT), methylisothiazolinone (MIT), methylchloroisothiazolinone (CMIT), and combinations thereof.

According to an eighteenth aspect of the present disclosure, the biocidal paint of any one of aspects 15-17, wherein the co-biocide is a bicyclic oxazolidine selected from 5-hydroxymethyl-1-aza-3,7-dioxabicyclo-(3.3.0) octane, 5-hydroxymethoxymethyl-1-aza-3,7-dioxabicyclo-(3.3.0) octane, 5-hydroxypoly(methyleneoxy)methyl-1-aza-3,7-dioxabicyclo-(3.3.0) octane, and combinations thereof.

According to a nineteenth aspect of the present disclosure, the biocidal paint of any one of aspects 15-18, wherein the co-biocide is a bromine nitrogen-based compound, and wherein the bromine nitrogen-based compound is 2-bromo-2-nitro-1,3-propanediol.

According to a twentieth aspect of the present disclosure, the biocidal paint of any one of aspects 15-19, wherein the film-forming component comprises at least one material selected from polystyrenes, high impact polystyrenes, polycarbonates, nylon, polyamides, poly(acrylonitrile-butadiene-styrene), polycarbonate-poly(acrylonitrile-butadiene-styrene) blends, polybutylene terephthalate, polybutylene terephthalate co-polymers, polyethylene terephthalate, polyethylene terephthalate co-polymers, polyolefins, polyethylenes, polypropylenes, cyclic polyolefins, modified polyphenylene oxide, polyvinylchloride, acrylic polymers, polymethyl methacrylate, thermoplastic elastomers, thermoplastic urethanes, styrene acrylic polymers, alkyd emulsions, vinyl acetate polymers, vinyl alkylate co-polymers, vinyl acetate-acrylic acid co-polymers, vinyl acetate-ethylene co-polymers, and polyetherimides.

According to a twenty-first aspect of the present disclosure, the biocidal paint of any one of aspects 15-20, wherein a ratio of an amount of the plurality of copper-containing glass particles to an amount of the at least one co-biocide provides biocidal synergy.

According to a twenty-second aspect of the present disclosure, the biocidal paint of any one of aspects 15-21, wherein the plurality of copper-containing glass particles contains a cuprite phase comprising a plurality of Cu¹⁺ ions, and comprises at least one of B₂O₃, P₂O₅, and R₂O, wherein R is an alkali metal selected from K, Na, Li, Rb, and Cs.

According to a twenty-third aspect of the present disclosure, the biocidal paint of aspect 22, wherein the plurality of copper-containing glass particles further comprises a glass phase comprising more than 40 mol % SiO₂.

According to a twenty-fourth aspect of the present disclosure, the biocidal paint of aspect 23, wherein the glass phase is present in an amount by weight greater than the cuprite phase.

According to a twenty-fifth aspect of the present disclosure, the biocidal paint of aspect 23 or aspect 24, wherein the cuprite phase is dispersed in the glass phase.

According to a twenty-sixth aspect of the present disclosure, the biocidal paint of any one of aspects 23-25, wherein either one or both of the cuprite phase and the glass phase comprise Cu¹⁺ ions.

According to a twenty-seventh aspect of the present disclosure, the biocidal paint of any one of aspects 22-26, wherein the cuprite phase comprises crystals having an average major dimension of about 0.5 micrometers (μm) or less.

According to a twenty-eighth aspect of the present disclosure, the biocidal paint of any one of aspects 22-27, wherein the cuprite phase is degradable and leaches in the presence of water.

To the extent not already described, the different features of the various aspects of the present disclosure may be used in combination with each other as desired. That a particular feature is not explicitly illustrated or described with respect to each aspect of the present disclosure is not meant to be construed that it cannot be, but it is done for the sake of brevity and conciseness of the description. Thus, the various features of the different aspects may be mixed and matched as desired to form new aspects, whether or not the new aspects are expressly disclosed.

It will be apparent to those skilled in the art that various modifications and variations can be made without departing from the spirit or scope of the invention.

1. A biocidal material, comprising:
a carrier; and
a plurality of copper-containing glass particles; and
at least one co-biocide selected from isothiazolinones, bicyclic oxazolidines, and bromine nitrogen-based compounds, and
wherein a minimum bactericidal concentration (MBC) of a combination of the at least one co-biocide and the plurality of copper-containing glass particles is less than an MBC of the at least one co-biocide in the absence of the plurality of copper-containing glass particles, and
wherein a ratio of the amount of the at least one co-biocide to the amount of copper-containing glass particles (in weight percent) is from about 3:1 to about 1:3.

2. The biocidal material of claim 1, wherein the MBC of the combination of the at least one co-biocide and the plurality of copper-containing glass particles is less than the MBC of the at least one co-biocide in the absence of the plurality of copper-containing glass particles by at least about 40%.

3. The biocidal material of claim 1, wherein the co-biocide is an isothiazolinone selected from benzisothiazolinone (BIT), octylisothiazolinone (OIT), methylisothiazolinone (MIT), methylchloroisothiazolinone (CMIT), and combinations thereof.

4. The biocidal material of claim 1, wherein the co-biocide is a bicyclic oxazolidine selected from 5-hydroxymethyl-1-aza-3.7-dioxabicyclo-(3.3.0) octane, 5-hydroxymethoxymethyl-1-aza-3,7-dioxabicyclo-(3.3.0) octane, 5-hydroxypoly(methyleneoxy)methyl-1-aza-3,7-dioxabicyclo-(3.3.0) octane, and combinations thereof.

5. The biocidal material of claim 1, wherein the co-biocide is a bromine nitrogen-based compound, and wherein the bromine nitrogen-based compound is 2-bromo-2-nitro-1,3-propanediol.

6. The biocidal material of claim 1, wherein the plurality of copper-containing glass particles contains a cuprite phase comprising a plurality of Cu¹⁺ ions, and comprises at least one of B₂O₃, P₂O₅, and R₂O, wherein R is an alkali metal selected from K, Na, Li, Rb, and Cs.

7. The biocidal material of claim 6, wherein the plurality of copper-containing glass particles further comprises a glass phase comprising more than 40 mol % SiO₂.

8. The biocidal material of claim 7, wherein the glass phase is present in an amount by weight greater than the cuprite phase.

9. The biocidal material of claim 7, wherein the cuprite phase is dispersed in the glass phase.

10. The biocidal material of claim 7, wherein either one or both of the cuprite phase and the glass phase comprise Cu¹⁺ ions.

11. The biocidal material of claim 6, wherein the cuprite phase comprises crystals having an average major dimension of about 0.5 micrometers (μm) or less.

12. The biocidal material of claim 6, wherein the cuprite phase is degradable and leaches in the presence of water.

13. (canceled)

14. The biocidal material of claim 1, wherein a ratio of an amount of the plurality of copper-containing glass particles to an amount of the at least one co-biocide provides biocidal synergy.

15. A biocidal paint, comprising:
a film-forming component;
a solvent;
a plurality of copper-containing glass particles; and
at least one co-biocide selected from isothiazolinones, bicyclic oxazolidines, and bromine nitrogen-based compounds,
wherein a minimum bactericidal concentration (MBC) of a combination of the at least one co-biocide and the plurality of copper-containing glass particles is less than an MBC of the at least one co-biocide in the absence of the plurality of copper-containing glass particles, and
wherein a ratio of the amount of the at least one co-biocide to the amount of copper-containing glass particles (in weight percent) is from about 3:1 to about 1:3.

16. (canceled)

17. The biocidal paint of claim 15, wherein the co-biocide is an isothiazolinone selected from benzisothiazolinone (BIT), octylisothiazolinone (OIT), methylisothiazolinone (MIT), methylchloroisothiazolinone (CMIT), and combinations thereof.

18. The biocidal paint of claim 15, wherein the co-biocide is a bicyclic oxazolidine selected from 5-hydroxymethyl-1-aza-3,7-dioxabicyclo-(3.3.0) octane, 5-hydroxymethoxymethyl-1-aza-3,7-dioxabicyclo-(3.3.0) octane, 5-hydroxypoly(methyleneoxy)methyl-1-aza-3,7-dioxabicyclo-(3.3.0) octane, and combinations thereof.

19. The biocidal paint of claim 15, wherein the co-biocide is a bromine nitrogen-based compound, and wherein the bromine nitrogen-based compound is 2-bromo-2-nitro-1,3-propanediol.

20. The biocidal paint of claim 15, wherein the film-forming component comprises at least one material selected from polystyrenes, high impact polystyrenes, polycarbonates, nylon, polyamides, poly(acrylonitrile-butadiene-styrene), polycarbonate-poly(acrylonitrile-butadiene-styrene) blends, polybutylene terephthalate, polybutylene terephthalate co-polymers, polyethylene terephthalate, polyethylene terephthalate co-polymers, polyolefins, polyethylenes, polypropylenes, cyclic polyolefins, modified polyphenylene oxide, polyvinylchloride, acrylic polymers, polymethyl methacrylate, thermoplastic elastomers, thermoplastic urethanes, styrene acrylic polymers, alkyd emulsions, vinyl acetate polymers, vinyl alkylate co-polymers, vinyl acetate-acrylic acid co-polymers, vinyl acetate-ethylene co-polymers, and polyetherimides.

21. (canceled)

22. The biocidal paint of claim 15, wherein the plurality of copper-containing glass particles contains a cuprite phase comprising a plurality of Cu¹⁺ ions, and comprises at least one of B₂O₃, P₂O₅, and R₂O, wherein R is an alkali metal selected from K, Na, Li, Rb, and Cs.

23-26. (canceled)

27. The biocidal paint of claim 22, wherein the cuprite phase comprises crystals having an average major dimension of about 0.5 micrometers (μm) or less.

28. (canceled)
